(19) United States
(12) Patent Application Publication
(10) Pub. No.: US 2025/0254442 A1
(43) Pub. Date: Aug. 7, 2025

(54) IMAGE PROCESSING APPARATUS, IMAGE CAPTURE APPARATUS, AND IMAGE PROCESSING METHOD

(71) Applicant: CANON KABUSHIKI KAISHA, Tokyo (JP)

(72) Inventor: Emi KAWAI, Kanagawa (JP)

(21) Appl. No.: 19/033,670

(22) Filed: Jan. 22, 2025

(30) Foreign Application Priority Data
Feb. 5, 2024 (JP) 2024-015840

(51) Int. Cl. H04N 25/68

(52) U.S. Cl. CPC H04N 25/68

(57) ABSTRACT

An image processing apparatus that executes, on image data, predetermined processing for suppressing effects due to defective pixels included in an image sensor used to capture the image data. The apparatus comprises a first processing unit that applies the predetermined processing without using any machine learning model and a second processing unit that applies the predetermined processing using a machine learning model. The apparatus controls whether the predetermined processing is to be executed by one of the first and second processing units or by both the first and second processing units in a shared manner.

### BACKGROUND OF THE INVENTION

### Field of the Invention

The present invention relates to an image processing apparatus, an image capture apparatus, and an image processing method. The present invention particularly relates to a defective pixel correction technology.

### Description of the Related Art

Currently, image sensors used in digital cameras typically have more than 10 million pixels. Therefore, the pixels of an image sensor may include pixels with abnormal output (imperfect pixels or defective pixels) due to manufacturing errors or the like. Also, defective pixels may occur after manufacturing due to radiation or the like.

Japanese Patent Laid-Open No. 2021-122106 has proposed a technology in which defective pixels having occurred after manufacturing are estimated using a machine learning model, and the estimated defective pixels are corrected based on signals of surrounding normal pixels.

However, the use of a machine learning model requires a large number of calculations, and thus a configuration that constantly uses a machine learning model is disadvantageous in terms of processing time and power consumption. Accordingly, it is desirable to realize a technology capable of flexibly controlling the use of a machine learning model in processing related to defective pixels.

### SUMMARY OF THE INVENTION

In view of such problems of the conventional technology, the present invention provides, in an embodiment, an image processing apparatus and an image processing method that are capable of flexibly controlling the use of a machine learning model in processing related to defective pixels.

According to an aspect of the present invention, there is provided an image processing apparatus that executes, on image data, predetermined processing for suppressing effects due to defective pixels included in an image sensor used to capture the image data, comprising one or more processors that execute one or more programs stored in a memory and thereby function as: a first processing unit configured to apply the predetermined processing without using any machine learning model; a second processing unit configured to apply the predetermined processing using a machine learning model; and a control unit configured to control operations of the first processing unit and the second processing unit, wherein the control unit controls whether the predetermined processing is executed by one of the first processing unit and the second processing unit, or is executed in a shared manner by both the first processing unit and the second processing unit.

According to another aspect of the present invention, there is provided an image capture apparatus comprising: an image sensor; and an image processing apparatus that executes predetermined processing on image data obtained using the image sensor, wherein the image processing apparatus comprising one or more processors that execute one or more programs stored in a memory and thereby function as: a first processing unit configured to apply the predetermined processing without using any machine learning model; a second processing unit configured to apply the predetermined processing using a machine learning model; and a control unit configured to control operations of the first processing unit and the second processing unit, wherein the control unit controls whether the predetermined processing is executed by one of the first processing unit and the second processing unit, or is executed in a shared manner by both the first processing unit and the second processing unit.

According to a further aspect of the present invention, there is provided an image processing method of executing predetermined processing on image data by an image processing apparatus, wherein the predetermined processing is for suppressing effects due to defective pixels included in an image sensor used to capture the image data, and wherein the image processing apparatus comprises a first processing unit that executes the predetermined processing without using machine learning model, and a second processing unit that execute the predetermined processing using a machine learning model, the image processing method comprising: controlling the first processing unit and the second processing unit, wherein the controlling includes: controlling one of the first processing unit and the second processing unit to execute the predetermined processing, or controlling both the first processing unit and the second processing unit to execute the predetermined processing a shared manner.

Further features of the present invention will become apparent from the following description of exemplary embodiments (with reference to the attached drawings).

### BRIEF DESCRIPTION OF THE DRAWINGS

FIG. 1 is a block diagram showing an example of a functional configuration of a digital camera serving as an example of an image processing apparatus according to an embodiment.

FIG. 2 is a diagram showing examples of processing that a control unit assigns to two repair processing units according to the embodiment.

FIG. 3 is a diagram illustrating an example operation of repair processing according to the embodiment.

FIG. 4 is a diagram illustrating another example operation of repair processing according to the embodiment.

FIG. 5 is a diagram illustrating yet another example operation of repair processing according to the embodiment.

FIG. 6 is a diagram illustrating yet another example operation of repair processing according to the embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

Note that the following embodiments will describe a case where the present invention is implemented in a digital camera with an interchangeable lens. However, the present invention can be implemented in any electronic device capable of processing image data obtained using an image sensor. Such electronic devices include computer devices (such as personal computers, tablet computers, media players, and PDAs), smartphones, game consoles, robots, drones, drive recorders, and head-mounted displays (HMDs). These are examples and the present invention can be implemented in other electronic devices.

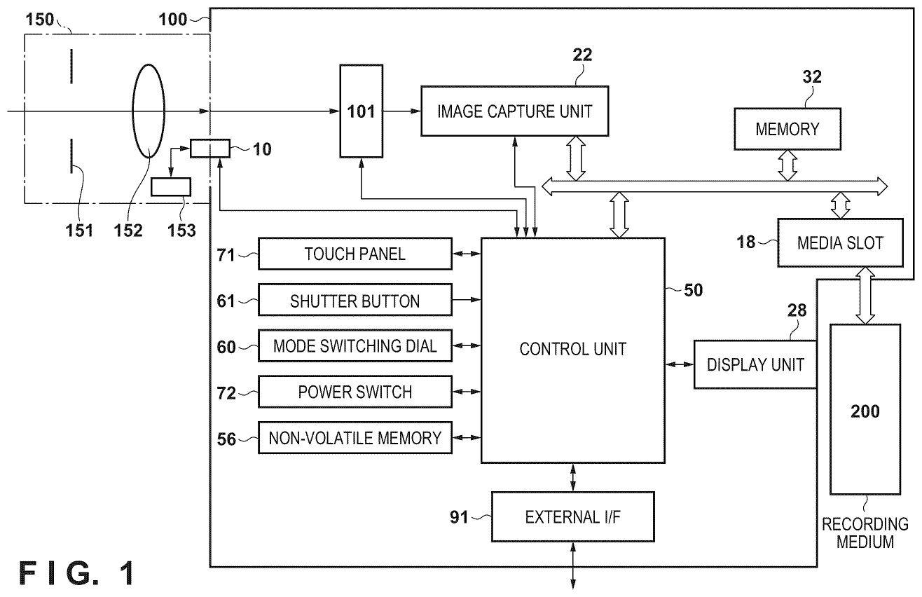

FIG. 1 is a block diagram showing an example of a functional configuration of a digital camera 100 serving as an example of an image processing apparatus according to an embodiment of the present invention.

A lens unit 150 is an interchangeable lens that can be detached to and from the digital camera 100. The lens unit 150 includes a diaphragm 151 and a drive circuit for the diaphragm 151, a lens group 152 and a drive circuit for the lens group 152, a lens control unit 153, and the like. The lens group 152 includes a movable lens such as a focus lens. A lens unit 150 may be fixed to the digital camera 100.

A power for the lens unit 150 is supplied from the digital camera 100 through a communication terminal 10. A control unit 50 transmits commands to the lens control unit 153 via the communication terminal 10 to control the operation of the lens unit 150 and adjust the aperture value and focal distance.

A shutter 101 is a focal plane shutter that opens and closes under the control of the control unit 50 that will be described later, in response to the operation of a shutter button 61.

An image capture unit 22 includes an image sensor and outputs a group of pixel signals (analog image signals) representing a subject image formed on the imaging surface by the lens group 152. The image sensor may be a well-known CCD or CMOS color image sensor with primary color filters in a Bayer array, for example. The image sensor includes a pixel array in which multiple pixels are arranged in a two-dimensional array, and peripheral circuits for reading out signals from the pixels. Each pixel accumulates a charge corresponding to the amount of incident light due to photoelectric conversion. As a result of a signal with a voltage corresponding to the amount of charge accumulated during an exposure period being read from each pixel, the group of pixel signals (analog image signals) representing a subject image formed on the imaging surface is obtained.

The control unit 50 is constituted by, for example, one or more processors (such as CPU, MPU, and a microprocessor) capable of executing a program. By reading a program stored in a non-volatile memory 56 into a memory 32 and executing the read program, the control unit 50 controls the operations of the constituent components of the digital camera 100 and realizes the function of the digital camera 100. The control unit 50 also communicates with the lens control unit 153 to control the operation of the lens unit 150.

Also, the control unit 50 applies various types of image processing to the analog image signals read from the image capture unit 22. Examples of the image processing applied by the control unit 50 can include preprocessing, color interpolation processing, correction processing, detection processing, data processing, evaluation value calculation processing, and special effect processing.

Preprocessing can include A/D conversion, signal amplification, reference level adjustment, later-described repair processing, and the like.

Color interpolation processing is performed when the image sensor has a color filter and interpolates the values of color components that are not included in the respective pixel data constituting the image data. Color interpolation processing is also referred to as demosaicing processing.

Correction processing can include processing such as noise suppression, white balance adjustment, tone correction, correction (image recovery) of image degradation caused by optical aberrations of the lens unit 150, correction of the effect of vignetting of the lens unit 150, and color correction.

Detection processing can include detection of feature regions (e.g., a face region and a body region) and their motion, recognition of persons, and the like.

Data processing can include processing such as cropping of regions, compositing, scaling, encoding and decoding, and header information generation (data file generation). Generation of image data for display and image data for recording is also included in data processing.

Evaluation value calculation processing can include processing such as generation of signals and evaluation values for use in automatic focus detection (AF), and generation of evaluation values for use in automatic exposure control (AE).

Special effect processing can include processing such as adding blur effects, changing color tones, and relighting.

Note that these are examples of processing that the control unit 50 can apply, and there is no limitation on the processing that the control unit 50 applies. Also, at least part of the image processing described above may be performed in a hardware circuit other than the control unit 50. For example, later-described repair processing using a machine learning model can be executed using a hardware circuit capable of performing neural network-related calculations at a high speed. A graphics processing unit (GPU) and a neural processing unit (NPU) are known as such hardware circuits.

The non-volatile memory 56 is electrically rewritable, and stores programs to be executed by the control unit 50, various settings for the digital camera 100, GUI data, and the like. A set of parameters that define a later-described machine learning model is also stored in the non-volatile memory 56. Information (a priori defect data) on a defective pixel generated during manufacturing can also be stored in the non-volatile memory 56. The priori defect data can include, for example, the position and type (such as always-on and always-off) of the defective pixel.

The memory 32 is a RAM, and is used as a main memory for temporarily holding a program and intermediate data executed by the control unit 50, as a buffer memory for image data and other types of data, and as a video memory for a display unit 28.

A mode switching dial 60 switches the operation mode of the digital camera 100. The operation modes include, for example, a still image shooting mode, a moving image shooting mode, and a playback mode. Note that the operation modes that can be switched by the mode switching dial may be further divided into multiple operation modes. In this case, the final operation mode may be selected using another means, such as a menu screen.

The shutter button 61 can be operated by being pressed halfway and by being pressed fully. The control unit 50 recognizes the halfway-pressed operation of the shutter button 61 as an instruction to prepare for shooting a still image and executes shooting preparatory operations such as automatic exposure control (AE) and automatic focus detection (AF). The control unit 50 also recognizes the fully-pressed operation of the shutter button 61 as an instruction to start shooting a still image and executes opening and closing of the shutter 101 according to exposure conditions and generation of image data for recording.

A power switch 72 switches on and off the power of the digital camera 100.

The display unit 28 is a liquid crystal display or an organic electro-luminescent display having a touch panel 71 on the display screen. The display unit 28 displays setting screens (menu screens), shot images, and information on the digital camera 100 under the control of the control unit 50.

A removable recording medium 200 such as a memory card can be inserted into a media slot 18. Note that the digital camera 100 may have a built-in storage device.

An external interface (I/F) 91 is a communication interface for communication with external devices. The external I/F 91 has circuits, antennas, connectors, and the like that are necessary to perform communication with external devices in compliance with one or more wired or wireless communication standards. Standards that the external I/F 91 may comply with include, but are not limited to, wireless LAN, Bluetooth (registered trademark), USB, HDMI (registered trademark), Serial Digital Interface (SDI), and the like, for example.

In the present embodiment, the control unit 50 can selectively provide one or both of a non-ML-based first repair processing function of applying repair processing without using a machine learning (ML) model, and a ML-based second repair processing function of applying repair processing using a machine learning model. The repair processing is predetermined processing for suppressing effects due to defective pixels included in the image sensor used to capture image data. The repair processing includes processing related to detection of the defective pixels and processing related to correction of signals of the detected pixels.

The machine learning model may be a neural network that has been trained with training data for the purpose. Actually, the control unit 50 applies the repair processing using the ML model to input data, by performing calculations on the input data using the set of parameters that define the machine learning model. It is assumed that the group of parameters that define the machine learning model has been stored in the non-volatile memory 56 in advance.

The control unit 50 controls the first repair processing function and the second repair processing function such that the following processes of:
(1) detecting a first type of defective pixel (a priori defect) generated in the manufacturing process of the image sensor;
(2) detecting a second type of defective pixel (a posteriori defect) generated after the manufacturing process of the image sensor (after the priori defect has been registered);
(3) correcting the priori defect; and
(4) correcting the posteriori defect,
   are executed by one of the first repair processing function and the second repair processing function, or executed in a shared manner by both of the first repair processing function and the second repair processing function.

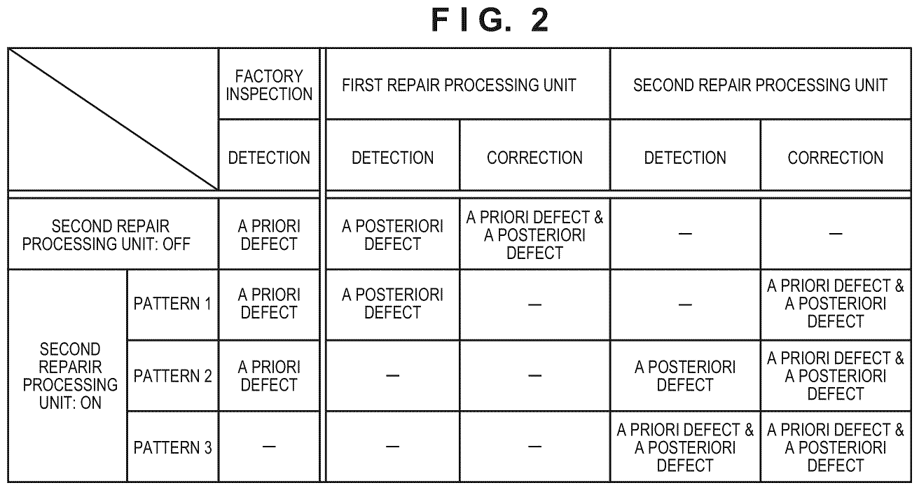

FIG. 2 shows the combination of processes (1) to (4) assigned to the first repair processing function and the second repair processing function by the control unit 50, according to the present embodiment. In FIG. 2, the processing of the control unit 50 to which the first repair processing function is applied is denoted as a first repair processing unit (non-ML based), and the processing of the control unit 50 to which the second repair processing function is applied is denoted as a second repair processing unit (ML based). The control unit 50 can select one of the four combinations shown in FIG. 2.

“Second repair processing unit: OFF” corresponds to the case where the second repair processing function is not used. In this case, the first repair processing function (non-ML based first repair processing function) executes all of the processes (1) to (4).

Pattern 1 and Pattern 2 of “second repair processing unit: ON” both use the first repair processing function and the second repair processing function, but assignment of processing for these functions is different.

Pattern 3 of “second repair processing unit: ON” corresponds to the case where the first repair processing function is not used. In this case, the second repair processing function (ML-based second repair processing unit) executes all of the processes (1) to (4).

RAW Data Processing (when no machine learning model is used for repair processing)

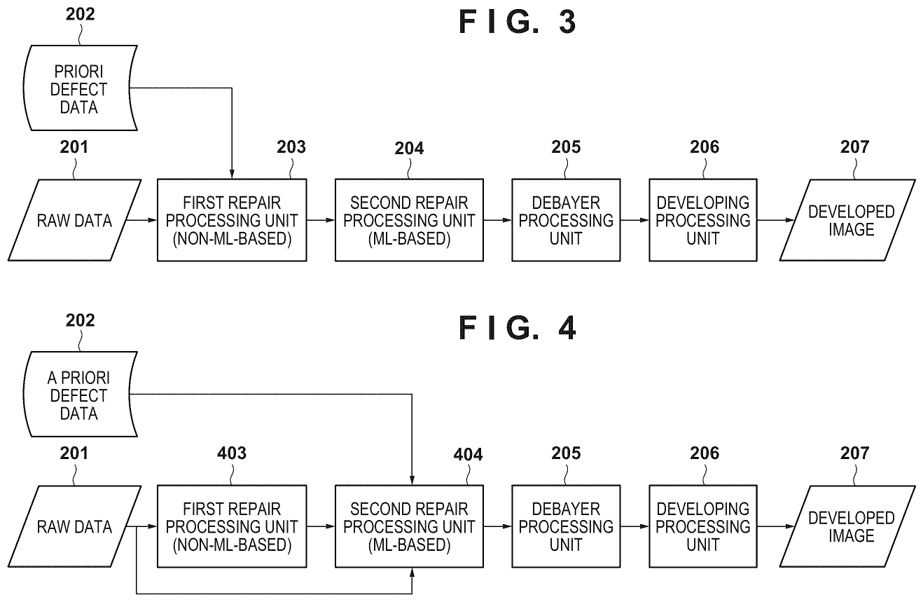

FIG. 3 is a schematic diagram of processing processes that the control unit 50 applies to RAW data in case of “second repair processing: OFF” according to the present embodiment. In FIG. 3, blocks 203, 205, and 206 represent the processing processes of the control unit 50 as functional blocks, respectively. Actually, these functional blocks are realized by the control unit 50 executing a program stored in the non-volatile memory 56.

Here, RAW data has a data format as of a group of pixel signals being read from the image capture unit 22, and each pixel has a luminance value of one color component. One color component corresponds to the color of the color filter provided for the corresponding pixel. For example, if the image sensor is provided with primary color filters in a Bayer array, each of the pixel signals constituting the RAW data has a luminance value of one of the color components red, blue, and green.

As described above, in the case of “second repair processing unit: OFF”, no machine learning model is used for repair processing, and thus the second repair processing unit does not exist. In this case, a first repair processing unit 203 (control section 50) detects a priori defect by reading priori defect data 202 from the image capture unit 22 or the non-volatile memory 56, for example. The first repair processing unit 203 also detects a posteriori defect based on a group of pixel signals read from the image sensor with the shutter 101 closed, for example. A posteriori defect can be detected as a pixel that has an abnormal signal level and is not included in the priori defect data, for example. The first repair processing unit 203 stores information on the detected posteriori defect in, for example, the memory 32 as posteriori defect data.

Furthermore, the first repair processing unit 203 performs defect correction processing to correct the signal levels of defective pixels detected as a priori defect and a posteriori defect, using the priori defect data and the posteriori defect data. The defect correction processing may be processing of replacing the signal level of a defective pixel with a signal level obtained by interpolating the signal levels of a plurality of normal pixels in the surroundings of the defective pixel. Note that because the first repair processing unit 203 performs defect correction on the RAW data 201, the first repair processing unit 203 performs defect correction using the signal levels of the surrounding normal pixels that have the same color filter as the color filter of the defective pixel.

A debayer processing unit 205 generates the luminance values of the two missing color components for each of the pixel signals that make up the RAW data. This processing is also referred to as color interpolation processing or demosaicing processing. For example, for a pixel signal with only a red component, the debayer processing unit 205 generates a luminance value of a blue component from multiple surrounding pixel signals with only a blue color component, and a luminance value of a green component from multiple surrounding pixel signals with only a green color component. The debayer processing unit 205 also performs the same processing on the pixel signals having only a blue component and the pixel signals having only a green component.

A developing processing unit 206 generates a developed image 207 by applying necessary processing selected from the above-described various types of image processing, depending on the intended use of the image data and the settings of the digital camera 100. The developed image 207 is, for example, image data in compliance with a still image or moving image standard (such as JPEG and MPEG). The developed image 207 is displayed on the display unit 28, recorded on the recording medium 200, or transmitted to the outside through the external I/F 91, depending on the intended use.

### RAW Data Processing (When a Machine Learning Model is Used for Repair Processing—Pattern 1)

FIG. 4 is a schematic diagram of processing processes that the control unit 50 applies to RAW data in case of Pattern 1 of “second repair processing: ON” according to the present embodiment. In FIG. 4, the same reference numerals are added to the same components as in FIG. 3, and redundant descriptions are omitted. Blocks 403, 404, 205, and 206 represent the processing processes of the control unit 50 as functional blocks, respectively. Actually, these functional blocks are realized by the control unit 50 executing a program stored in the non-volatile memory 56.

As shown in FIG. 2, in Pattern 1, a non-ML-based first repair processing unit 403 performs detection of priori and posteriori defects, and a ML-based second repair processing unit 404 performs defect correction. The first repair processing unit 403 is the same as the first repair processing unit 203 described with reference to FIG. 3, except that the first repair processing unit 403 does not perform defect correction. The first repair processing unit 403 outputs priori defect data and posteriori defect data to the second repair processing unit 404.

The second repair processing unit 404 uses, as a machine learning model, a neural network that has been subjected to supervised learning using the following training data set. The machine learning model outputs image data obtained by correcting the priori defect and the posteriori defect.

### Training Data Set

Input data: priori defect data, posteriori defect data, RAW data before defect correction.
Teaching data: RAW data after defect correction

Note that by including erroneous detection results in posteriori defect data for use as input data, erroneous correction to a posteriori defect that was erroneously detected by the first repair processing unit 403 can be suppressed. Particularly, it is possible to suppress erroneous correction to images of scenes such as night scenes and starry skies for which posteriori defect detection without using a machine learning model is difficult.

Note that, of the input data for the machine learning model, the priori defect data and the posteriori defect data are character information such as image coordinates, whereas the RAW data is two-dimensional image data. Therefore, the machine learning model used by the first repair processing unit 403 is configured to accept character information and two-dimensional image data as input data, and output two-dimensional image data. There is no particular limitation on the configuration of the machine learning model, and any known configuration can be used, for example, a configuration in which a known multimodal neural network is used. Also, in later-described Patterns 2 and 3, individual machine learning models are prepared according to the type and number of pieces of input data.

The downstream processing on the defect-corrected RAW data output by the second repair processing unit 404 is as described with reference to FIG. 3, and therefore, the description is omitted.

Note that in view of the defect correction processing being performed by the second repair processing unit 404, it is also possible to set a different detection threshold for posteriori defects used by the first repair processing unit 403 from the detection threshold used by the first repair processing unit 203. Specifically, erroneous correction is expected to be suppressed by the second repair processing unit 404, and thus it is possible to change the detection threshold so that more posteriori defects are detected.

### RAW Data Processing (When a Machine Learning Model is Used for Repair Processing—Pattern 2)

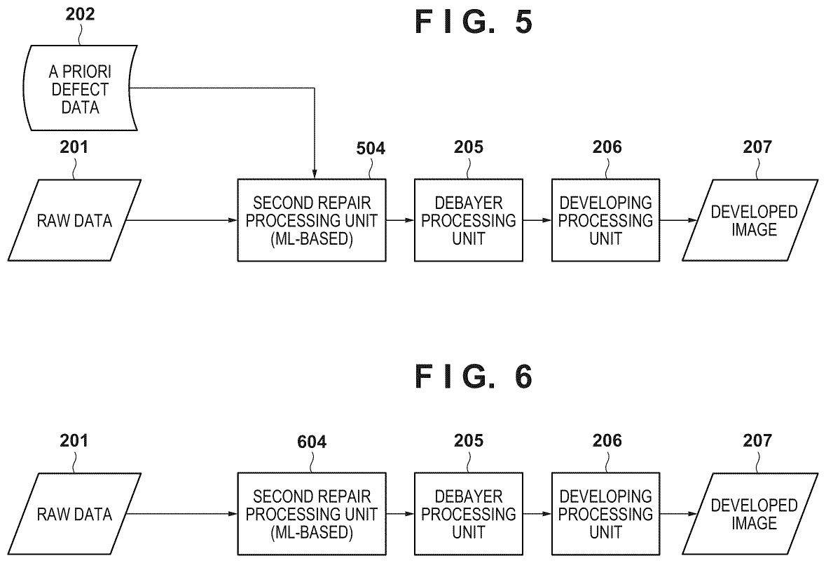

FIG. 5 is a schematic diagram of processing processes that the control unit 50 applies to RAW data in case of Pattern 2 of “second repair processing: ON” according to the present embodiment. In FIG. 5, the same reference numerals are added to the same components as in FIG. 3, and redundant descriptions are omitted. Blocks 504, 205, and 206 represent the processing processes of the control unit 50 as functional blocks. Actually, these functional blocks are realized by the control unit 50 executing a program stored in the non-volatile memory 56.

As shown in FIG. 2, in Pattern 2, the non-ML-based first repair processing unit 203 is not used, and detection of posteriori defects and defect correction are executed by a ML-based second repair processing unit 504.

The second repair processing unit 504 uses, as a machine learning model, a neural network that has been subjected to supervised learning using the following training data set. The machine learning model outputs image data obtained by correcting the priori defect and the posteriori defect.

### Training Data Set

Input data: priori defect data, RAW data before defect correction
Teaching data: RAW data after defect correction

### RAW Data Processing (When a Machine Learning Model is Used for Repair Processing—Pattern 3)

FIG. 6 is a schematic diagram of processing processes that the control unit 50 applies to RAW data in case of Pattern 3 of “second repair processing: ON” according to the present embodiment. In FIG. 6, the same reference numerals are added to the same components as in FIG. 3, and redundant descriptions are omitted. Blocks 604, 205, and 206 represent the processing processes of the control unit 50 as functional blocks. Actually, these functional blocks are realized by the control unit 50 executing a program stored in the non-volatile memory 56.

As shown in FIG. 2, in Pattern 3, similar to Pattern 2, the non-ML-based first repair processing unit 203 is not used. Pattern 3 differs from Pattern 2 in that priori defect data is not used and a ML-based second repair processing unit 604 detects both priori and posteriori defects.

The second repair processing unit 604 uses, as a machine learning model, a neural network that has been subjected to supervised learning using the following training data set. The machine learning model outputs image data obtained by correcting the priori defect and the posteriori defect.

### Training Data Set

Input data: RAW data before defect correction.
Teaching data: RAW data after defect correction

Accordingly, the digital camera 100 of the present embodiment can flexibly control the use of a machine learning model in the processing related to defective pixels. Therefore, various effects can be realized by dynamically changing the degree of use of the machine learning model according to various conditions.

For example, based on the analysis of a shooting scene and the shooting mode set at the time of image capture, if the image is considered to be of a scene for which the accuracy of posteriori defect detection is low without using a machine learning model, the control unit 50 can determine to use the second repair processing unit. In this case, the control unit 50 can execute Pattern 2 or 3. On the other hand, if the image is considered to be of a shooting scene where defect pixels are not noticeable or of a scene for which the accuracy of posteriori defect detection without using a machine learning model is not low, the control unit 50 can determine not to use the second repair processing unit. In this case, the control unit 50 can either not use any machine learning model or can execute Pattern 1. Note that the information on the shooting mode at the time of image capture can be obtained from the memory 32, for example. The information can also be obtained from metadata of the image data after recording.

Furthermore, if the remaining battery level of the digital camera 100 is less than or equal to a threshold, or if high-speed processing is required, the control unit 50 can determine not to use the second repair processing unit. In this case, the control unit 50 can either not use any machine learning model or can execute Pattern 1. Also, when the temperature of the image capture apparatus is high, defects in the image are more noticeable. Therefore, if the temperature of the image capture apparatus is higher than or equal to a threshold, or if the shutter speed is higher than or equal to a threshold (at long seconds), the control unit 50 can determine to use the second repair processing unit. In this case, the control unit 50 can execute Pattern 2 or 3, which is more effective for correction.

### Other Embodiments

In the above-described embodiment, a case has been described in which the control unit 50 is capable of executing Patterns 1 to 3, which use a machine learning model for processing related to defective pixels (repair processing). However, the effects of the present invention can be realized as long as both a case where a machine learning model is not used for repair processing and one or more of Patterns 1 to 3 are executable.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-015840, filed Feb. 5, 2024, which is hereby incorporated by reference herein in its entirety.

What is claimed is:

1. An image processing apparatus that executes, on image data, predetermined processing for suppressing effects due to defective pixels included in an image sensor used to capture the image data, comprising one or more processors that execute one or more programs stored in a memory and thereby function as:
a first processing unit configured to apply the predetermined processing without using any machine learning model;
a second processing unit configured to apply the predetermined processing using a machine learning model; and
a control unit configured to control operations of the first processing unit and the second processing unit,
wherein the control unit controls whether the predetermined processing is executed by one of the first processing unit and the second processing unit, or is executed in a shared manner by both the first processing unit and the second processing unit.

2. The image processing apparatus according to claim 1, wherein the predetermined processing includes processing related to detection of the defective pixels and processing related to correction of signals of the detected defective pixels, and
if the predetermined processing is executed in a shared manner by both the first processing unit and the second processing unit, the control unit controls the first processing unit and the second processing unit to execute the processing related to detection and the processing related to correction in a shared manner.

3. The image processing apparatus according to claim 2, wherein the control unit controls the operations of the first processing unit and the second processing unit such that the processing related to detection is executed by the first processing unit and the processing related to correction is executed by the second processing unit.

4. The image processing apparatus according to claim 2, wherein the processing related to detection includes processing related to detection of a first type of defective pixel generated in a process for manufacturing the image sensor, and processing related to detection of a second type of defective pixel generated after the manufacturing of the image sensor, and
the control unit controls the first processing unit to execute the processing related to detection of the first type of defective pixel and the second processing unit to execute the processing related to detection of the second type of defective pixel and the processing related to correction are executed by.

5. The image processing apparatus according to claim 2, wherein the processing related to detection includes processing related to detection of a first type of defective pixel generated in a process for manufacturing the image sensor, and processing related to detection of a second type of defective pixel generated after the manufacturing of the image sensor, and
the control unit controls one of the first processing unit and the second processing unit to execute the processing related to detection of the first type of defective pixel based on stored information on the first type of defective pixel.

6. The image processing apparatus according to claim 2, wherein the processing related to detection includes processing related to detection of a first type of defective pixel generated in a process for manufacturing the image sensor, and processing related to detection of a second type of defective pixel generated after the manufacturing of the image sensor, and
in a case where the second processing unit is to execute the predetermined processing, the control unit controls the second processing unit so as to execute the processing related to detection of the first type of defective pixel based on stored information on the first type of defective pixel, and execute the processing related to detection of the second type of defective pixel and the processing related to correction are executed using the machine learning model.

7. The image processing apparatus according to claim 2, wherein the processing related to detection includes processing related to detection of a first type of defective pixel generated in a process for manufacturing the image sensor, and processing related to detection of a second type of defective pixel generated after the manufacturing of the image sensor, and
in a case where the second processing unit is to execute the predetermined processing is executed, the control unit controls the second processing unit so as to execute, using the machine learning model, the processing related to detection of the first type of defective pixel, the processing related to detection of the second type of defective pixel, and the processing related to correction.

8. The image processing apparatus according to claim 1, wherein the control unit determines whether the second processing unit is to execute the predetermined processing, based on a shooting scene of the image data or a shooting mode during capture of the image data.

9. The image processing apparatus according to claim 1, wherein the control unit determines that the second processing unit is not to execute the predetermined processing in case where a remaining battery level of the image processing apparatus is less than or equal to a threshold.

10. The image processing apparatus according to claim 1, wherein the control unit determines that the second processing unit is to execute the predetermined processing in a case where a temperature of the image processing apparatus is greater than or equal to a threshold or a shutter speed used to capture the image data is longer than or equal to a threshold.

11. An image capture apparatus comprising:
an image sensor; and
an image processing apparatus that executes predetermined processing on image data obtained using the image sensor,
wherein the image processing apparatus comprising one or more processors that execute one or more programs stored in a memory and thereby function as:
a first processing unit configured to apply the predetermined processing without using any machine learning model;
a second processing unit configured to apply the predetermined processing using a machine learning model; and
a control unit configured to control operations of the first processing unit and the second processing unit,
wherein the control unit controls whether the predetermined processing is executed by one of the first processing unit and the second processing unit, or is executed in a shared manner by both the first processing unit and the second processing unit.

12. An image processing method of executing predetermined processing on image data by an image processing apparatus,
wherein the predetermined processing is for suppressing effects due to defective pixels included in an image sensor used to capture the image data, and
wherein the image processing apparatus comprises a first processing unit that executes the predetermined processing without using machine learning model, and a second processing unit that execute the predetermined processing using a machine learning model,
the image processing method comprising:
controlling the first processing unit and the second processing unit,
wherein the controlling includes:
controlling one of the first processing unit and the second processing unit to execute the predetermined processing, or
controlling both the first processing unit and the second processing unit to execute the predetermined processing a shared manner.
